(19) United States
(12) Patent Application Publication
(10) Pub. No.: US 2015/0024320 A1
(43) Pub. Date: Jan. 22, 2015

(54) ELECTROSTATIC LATENT IMAGE DEVELOPING TONER

(71) Applicant: KYOCERA Document Solutions Inc., Osaka (JP)

(72) Inventor: Erika TANAKA, Osaka (JP)

(73) Assignee: KYOCERA Document Solutions Inc., Osaka (JP)

(21) Appl. No.: 14/333,819

(22) Filed: Jul. 17, 2014

(30) Foreign Application Priority Data
Jul. 22, 2013 (JP) 2013-152005

(51) Int. Cl. G03G 9/113; G03G 9/087

(52) U.S. Cl. CPC G03G 9/1135; G03G 9/08733
USPC 430/108.22

(57) ABSTRACT

An electrostatic latent image developing toner includes toner particles. The toner particles each include a toner core containing a binder resin and a shell layer coating the surface of the toner core. The binder resin contains an ethylene-unsaturated carboxylic acid copolymer. The shell layers contain a unit derived from a monomer of a thermosetting resin. The thermosetting resin is at least one resin selected from the group of amino resins consisting of a melamine resin, a urea resin, and a glyoxal resin.

### INCORPORATION BY REFERENCE

The present application claims priority under 35 U.S.C. §119 to Japanese Patent Application No. 2013-152005, filed Jul. 22, 2013. The contents of this application are incorporated herein by reference in their entirety.

### BACKGROUND

The present disclosure relates to electrostatic latent image developing toners.

To provide energy-saving or compact image forming apparatuses, a toner having excellent low-temperature fixability is in demand. The use of a toner having excellent low-temperature fixability can ensure the toner to be appropriately fixed on a recording medium even though the temperature of a fixing roller is low.

To manufacture a toner having excellent low-temperature fixability, a method is suggested to use a binder resin having a low melting point (or a low glass transition point) and a mold releasing agent having a low melting point. Unfortunately, with such a method, it is difficult to manufacture a toner having excellent heat resistant preservability. The heat resistant preservability of a toner refers to the property that the toner particles of the toner remain unaggregated during the storage in a high-temperature environment. When a toner has low heat resistant preservability, the toner particles readily aggregate in a high-temperature environment. The amount of charge on the aggregated toner particles tends to be lower than that on non-aggregated toner particles.

In order to improve the toner in the low-temperature fixability, the heat resistant preservability, and the blocking resistance, a toner containing toner particles having a core-shell structure has been suggested.

In a toner containing toner particles having the core-shell structure, the toner cores contain a low melting point binder resin. In addition, each toner core is coated with a shell layer formed from a resin. The resin forming the shell layers has a glass transition point (Tg) that is higher than the glass transition point (Tg) of the binder resin contained in the toner cores.

According to a suggestion made for toner particles having the core-shell structure, each toner mother particle is coated with a shell layer and an external additive adheres to the surface of the toner mother particles. An example of the external additive is a compound containing an amino group. To prepare the toner particles of such a toner, for example, the particulates of an emulsified and dispersed binder resin and the particulates of a colorant are caused to aggregate and fuse in an aqueous medium to form aggregated and fused particles (toner cores). To an aqueous dispersion liquid containing such toner cores, another aqueous dispersion liquid (for example, an aqueous dispersion liquid in which the particulates of a positively chargeable, charge controllable resin containing a quaternary ammonium salt-containing acrylate unit are emulsified and dispersed) is added, followed by causing the particulates of the positively chargeable, charge controllable resin to be fused to the surface of a toner core to form the shell layers coating the toner core.

### SUMMARY

An electrostatic latent image developing toner according to the present disclosure includes toner particles. The toner particles each include a toner core containing a binder resin and a shell layer coating a surface of the toner core. The binder resin contains an ethylene-unsaturated carboxylic acid copolymer. The shell layers contain a unit derived from a monomer of a thermosetting resin. The thermosetting resin is at least one resin selected from the group of amino resins consisting of a melamine resin, a urea resin, and a glyoxal resin.

### DETAILED DESCRIPTION

The following describes an embodiment of the present disclosure in detail. The present disclosure is in no way limited to the embodiment below, and various alterations may be made to practice the present disclosure within the scope of the objects of the present disclosure. For the points where descriptions are overlapped, there may be cases where the description is omitted where appropriate, which, however, does not limit the contents of the disclosure.

A toner to which the present embodiment is directed is an electrostatic latent image developing toner. The toner contains toner particles each having a toner core and a shell layer coating the toner core. The toner core contains a binder resin. The binder resin contains an ethylene-unsaturated carboxylic acid copolymer. The toner cores may contain one or more additional components in the binder resin as needed, such as a colorant, a mold releasing agent, a charge control agent, and a magnetic powder. The shell layers are mainly formed from a resin. The resin forming the shell layers contain a unit derived from a monomer of a thermosetting resin.

The toner may be composed exclusively of toner particles or may include a component other than the toner particles. As needed, an external additive may be adhered to the surface of the toner particles. The toner may be mixed with a desired carrier to prepare a two-component developer. Throughout the specification and the claims of the present application, particles not yet treated with an external additive may be referred to as toner mother particles.

The following sequentially describes the toner cores (binder resin, colorant, mold releasing agent, charge control agent, and magnetic powder), the resin that forms the shell layers, the external additive, the carrier that is added for using the toner as a two-component developer, and the method for manufacturing the toner.

### [Binder Resin]

The toner cores of the toner particles contain a binder resin. The binder resin contains as an essential component an ethylene-unsaturated carboxylic acid copolymer having carboxyl groups. Thus, the carboxyl groups are exposed on the surface of the toner cores. The resin that forms the shell layers contains a unit derived from a monomer of at least one resin selected from the group of amino resins consisting of a melamine resin, a urea resin, and a glyoxal resin. The shell layers are formed by causing a monomer of such a thermosetting resin to react with formaldehyde or by using a precursor which is a methylolated monomer of the thermosetting resin with formaldehyde.

The toner particles of the toner according to the present embodiment are protected by the hard shell layers and therefore more resistant to rupturing even under a prolonged stress applied in a developing unit. In addition, the shell layers of such toner particles are more resistant to pealing from the toner cores. Therefore, the toner of the present disclosure exhibits excellent heat resistant preservability.

In addition, in the ethylene-unsaturated carboxylic acid copolymer, a plurality of carboxyl groups form hydrogen bonds. Consequently, the ethylene-unsaturated carboxylic acid copolymer exhibits an excellent mechanical strength in the temperature environment below the heating temperature for fixing the toner. On the other hand, in the temperature environment for fixing the toner, the ethylene-unsaturated carboxylic acid copolymer readily softens and flows.

Due to the above-described properties of the ethylene-unsaturated carboxylic acid copolymer, the toner particles of the toner according to the present disclosure (the toner particles prepared such that the toner cores contain the ethylene-unsaturated carboxylic acid copolymer as the binder resin) exhibit excellent low-temperature fixability to a recording medium and excellent resistance to rupturing of the particles even under a prolonged stress.

In addition, the ethylene-unsaturated carboxylic acid copolymer has the aliphatic characteristics derived from the structure of the main chain and the polarity derived from the carboxyl groups, and thus exhibits excellent compatibility with various mold releasing agents. Consequently, in the case where the toner according to the present disclosure contains a mold releasing agent, the mold releasing agent is readily dispersed in the binder resin contained in the toner cores.

The ethylene-unsaturated carboxylic acid copolymer is a resin obtained by copolymerizing at least ethylene, and a monomer containing an unsaturated carboxylic acid. The ethylene-unsaturated carboxylic acid copolymer may be used singly or two or more types may be used in combination. Specific examples of the unsaturated carboxylic acid include acrylic acid, methacrylic acid, ethacrylic acid, maleic acid, fumaric acid, itaconic acid, maleic anhydride, itaconic acid anhydride, monomethyl maleate, and monoethyl maleate. These unsaturated carboxylic acids may be used singly or two or more types may be used in combination. In view of the excellent polymerization reactivity with an ethylene-based monomer, (meth)acrylic acid is preferable as the unsaturated carboxylic acid.

The ethylene-unsaturated carboxylic acid copolymer may contain a monomer other than ethylene and unsaturated carboxylic acid. Examples of such a monomer other than ethylene and unsaturated carboxylic acid include vinyl esters (vinyl acetate and vinyl propionate) and unsaturated carboxylates (methyl acrylate, ethyl acrylate, iso-propyl acrylate, isobutyl acrylate, n-butyl acrylate, isooctyl acrylate, 2-ethylhexyl acrylate, methyl methacrylate, ethyl methacrylate, isobutyl methacrylate, dimethyl maleate, and maleic acid).

The total content of the unit derived from ethylene and the unit derived from the unsaturated carboxylic acid in the ethylene-unsaturated carboxylic acid copolymer is preferably 70% by mass or more of all the units constituting the ethylene-unsaturated carboxylic acid copolymer, more preferably 80% by mass or more, particularly preferably 90% by mass or more, and most preferably 100% by mass.

The content of the unit derived from the unsaturated carboxylic acid in the ethylene-unsaturated carboxylic acid copolymer is preferably 1% by mass or more and 15% by mass or less, and more preferably 5% by mass or more and 15% by mass or less. According to the present embodiment, the toner cores of the toner particles contain, as the binder resin, the ethylene-unsaturated carboxylic acid copolymer, and the content of the unit derived from the unsaturated carboxylic acid is 1% by mass or more and 15% by mass or less. Such toner particles exhibit excellent heat resistant preservability and are readily charged to have a desired charge amount. In addition, when a toner containing such toner particles is used to form images at a high coverage rate, occurrence of fogging in the images formed can be reduced.

Preferably, the melting point of the ethylene-unsaturated carboxylic acid copolymer is 80° C. or more and 110° C. or less. The melting point of the ethylene-unsaturated carboxylic acid copolymer can be measured according to ISO K7121:1987.

The melt flow rate (MFR) of the ethylene-unsaturated carboxylic acid copolymer is preferably 10 g/10 min or more and 500 g/10 min or less, and more preferably 50 g/10 min or more and 500 g/10 min or less. According to the present embodiment, the toner cores of the toner particles contain, as the binder resin, the ethylene-unsaturated carboxylic acid copolymer having the melt flow rate (MFR) that is 10 g/10 min or more and 500 g/10 min or less. Such toner particles are appropriately fixed to a recording medium even at low temperatures below 120° C. The melt flow rate (MFR) can be measured by using, for example, a melt indexer (“G-01” manufactured by Toyo Seiki Seisaku-sho, Ltd.) according to JIS K7210:1999 (at 190° C. with weight of 2.16 Kg).

With respect to a thermoplastic resin, the melt flow rate (MFR) is generally known to serve as an index of the molecular weight. The melt flow rate (MFR) of the ethylene-unsaturated carboxylic acid copolymer is adjusted by appropriately changing the manufacturing conditions according to a known method so as to adjust the molecular weight.

The binder resin may contain a thermoplastic resin other than the ethylene-unsaturated carboxylic acid copolymer. The thermoplastic resin other than the ethylene-unsaturated carboxylic acid copolymer is appropriately selected from thermoplastic resins conventionally used as a binder resin for a toner.

The content of the ethylene-unsaturated carboxylic acid copolymer in the binder resin is preferably 70% by mass or more, more preferably 80% by mass or more, particularly preferably 90% by mass or more, and most preferably 100% by mass.

### [Colorant]

The toner cores may contain a colorant as needed. For the colorant, a known pigment or dye may be used in accordance with the color of the toner particles. Specific examples of a preferred colorant include the following.

Examples of a black colorant include carbon black. In addition, a black colorant to be used may be a colorant adjusted to be a black color by combining the later-described colorants, such as a yellow colorant, a magenta colorant, and a cyan colorant.

For a color toner, examples of the colorant that can be contained in the toner cores include a yellow colorant, a magenta colorant, and a cyan colorant.

Examples of the yellow colorant include a condensed azo compound, an isoindolinone compound, an anthraquinone compound, an azo metal complex, a methine compound, and an allylamide compound. More specifically, examples of the yellow colorant include C.I. pigment yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, and 194), naphthol yellow S, Hansa yellow G, and C.I Vat yellow.

Examples of the magenta colorant include a condensed azo compound, a diketopyrrolopyrrole compound, an anthraquinone compound, a quinacridone compound, a basic dye lake compound, a naphthol compound, a benzimidazolone compound, a thioindigo compound, and a perylene compound. More specifically, examples of the magenta colorant include C.I. pigment red (2, 3, 5, 6, 7, 19, 23, 48:2, 48:3, 48:4, 57:1, 81:1, 122, 144, 146, 150, 166, 169, 177, 184, 185, 202, 206, 220, 221, and 254).

Examples of the cyan colorant include a copper phthalocyanine compound, a copper phthalocyanine derivative, an anthraquinone compound, and a basic dye lake compound. More specifically, examples of the cyan colorant include C.I. pigment blue (1, 7, 15, 15:1, 15:2, 15:3, 15:4, 60, 62, and 66), phthalocyanine blue, C.I. Vat blue, and C.I. acid blue.

Preferably, the amount of the colorant to be used is 1 part by mass or more and 30 parts by mass or less with respect to 100 parts by mass of the binder resin.

### [Mold Releasing Agent]

The toner cores may contain a mold releasing agent as needed. Typically, the mold releasing agent is used to improve the fixability or the offset resistance of the toner.

Preferred examples of the mold releasing agent include: aliphatic hydrocarbon-based waxes (such as low molecular weight polyethylene, low molecular weight polypropylene, polyolefin copolymer, polyolefin wax, microcrystalline wax, paraffin wax, and Fischer-Tropsch wax); oxides of the aliphatic hydrocarbon-based waxes (such as oxidized polyethylene wax, and block copolymers of oxidized polyethylene wax); plant waxes (such as candelilla wax, carnauba wax, Japan wax, jojoba wax, and rice wax); animal waxes (such as beeswax, lanolin, and spermaceti); mineral waxes (such as ozokerite, ceresin, and petrolatum); waxes containing a fatty acid ester as a major component (such as montanic acid ester wax, and castor wax); and waxes containing partially or fully deoxidized fatty acid ester (such as deoxidized carnauba wax).

The amount of the mold releasing agent to be used is preferably 1 part by mass or more and 30 parts by mass or less with respect to 100 parts by mass of the binder resin, and more preferably 5 parts by mass or more and 20 parts by mass or less.

### [Charge Control Agent]

The charge control agent is used to improve the charge level or the charge rising property, which serves as an index indicating as to whether the toner can be charged to a predetermined charge level within a short period of time, with the aim of providing the toner with excellent durability or stability. To positively charge the toner to perform the developing, the use of a positively chargeable charge control agent is preferred, whereas the use of a negatively chargeable charge control agent is preferred to negatively charge the toner to perform the developing. Yet, when the toner itself has sufficient chargeability, the use of any charge control agent is not necessary. For example, the shell layers may contain components having a charge function. In such a case, addition of a charge control agent to the toner cores is not necessary.

Specific examples of the positively chargeable charge control agent include azine compounds (such as pyridazine, pyrimidine, pyrazine, ortho-oxazine, meta-oxazine, para-oxazine, ortho-thiazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline), direct dyes made from an azine compound (such as azine fast red FC, azine fast red 12BK, azine violet BO, azine brown 3G, azine light brown GR, azine dark green BH/C, azine deep black EW, and azine deep black 3RL), nigrosine compounds (such as nigrosine, nigrosine salts, and nigrosine derivatives), acid dyes made from a nigrosine compound (such as nigrosine BK, nigrosine NB, and nigrosine Z), metal salts of naphthenic acids or of higher fatty acids, alkoxylated amines, alkylamides, and quaternary ammonium salts (such as benzyldecylhexylmethylammonium chloride and decyltrimethyl ammonium chloride). In addition, a resin including a quaternary ammonium salt, a carboxylate salt, or a carboxyl group is also usable as the positively chargeable charge control agent. Among these positively chargeable charge control agents, nigrosine compounds are particularly preferred in that the resulting toner will have a rapider charge rising property. These positively chargeable charge control agents may be used singly or two or more types may be used in combination.

Specific examples of the negatively chargeable charge control agent include organic metal complexes and chelate compounds. Preferred examples of the organic metal complexes and the chelate compounds include: metal acetylacetonate complexes, such as aluminum acetylacetonate, and iron (II) acetylacetonate; and salicylic acid-based metal complexes and salicylic acid-based metal salts, such as 3,5-di-tert-butylsalicylic acid chromium. Of these examples, the salicylic acid-based metal complexes and the salicylic acid-based metal salts are more preferred. These negatively chargeable charge control agents may be used singly or two or more types may be used in combination.

The amount of the positively or negatively chargeable charge control agent to be used is preferably 0.5 parts by mass or more and 20.0 parts by mass or less with respect to 100 parts by mass of the toner, and more preferably 1.0 part by mass or more and 15.0 parts by mass or less.

### [Magnetic Powder]

The toner cores may contain magnetic powder in the binder resin as needed. With the toner particles having the toner cores manufactured to contain magnetic powder, the toner is used as a magnetic one-component developer. Preferred examples of the magnetic powder include: iron, such as ferrite and magnetite; ferromagnetic metals, such as cobalt and nickel; alloys containing either or both of iron and ferromagnetic metal; compounds containing either or both of iron and ferromagnetic metal; ferromagnetic alloys subjected to ferromagnetization, such as a thermal treatment; and chromium dioxide.

The particle size of the magnetic powder is preferably 0.1 μm or more and 1.0 μm or less, and more preferably 0.1 μm or more and 0.5 μm or less. The magnetic powder having the particle size falling within such a range can be readily dispersed uniformly in the binder resin.

For a toner to be used as a one-component developer, the amount of the magnetic powder in the toner is preferably 35 parts by mass or more and 60 parts by mass or less with respect to 100 parts by mass of the toner, and more preferably 40 parts by mass or more and 60 parts by mass or less. For a toner to be used as a two-component developer, the amount of the magnetic powder in the toner is preferably 20 parts by mass or less with respect to 100 parts by mass of the toner, and more preferably 15 parts by mass or less.

### [Resin Forming Shell Layer]

The resin that forms the shell layers contain a unit derived from a monomer of a thermosetting resin. Throughout the specification and the claims of the present application, the “unit derived from a monomer of a thermosetting resin” refers to a unit obtained by introducing a methylene group (—CH₂—) derived from formaldehyde into a monomer such as melamine, for example. The following describes the monomer of the thermosetting resin that can be included in a resin for forming the shell layers.

### (Monomer of Thermosetting Resin)

The monomer used to introduce the unit derived from the monomer of the thermosetting resin into a resin for forming the shell layers is a monomer or an initial condensate used to form at least one thermosetting resin selected from the group of amino resins consisting of a melamine resin, a urea resin, and a glyoxal resin.

The melamine resin is a polycondensate of melamine and formaldehyde. The monomer used for forming a melamine resin is melamine. The urea resin is a polycondensate of urea and formaldehyde. The monomer used to form a urea resin is urea. The glyoxal resin is a polycondensate of formaldehyde and a reaction product of glyoxal and urea. The monomer used to form a glyoxal resin is a reaction product of glyoxal and urea. The melamine for forming the melamine resin, the urea for forming the urea resin, and the urea for reaction with glyoxal may each be denatured in a known manner. The monomer of the thermosetting resin may be methylolated (derivatized) with formaldehyde before the shell layer formation.

The ethylene-unsaturated carboxylic acid copolymer exhibits a high elasticity. Therefore, the toner particles having toner cores that contain the ethylene-unsaturated carboxylic acid copolymer as the binder resin elastically deform when stirred in the developing unit. As a result, sufficient frictional charge is not likely to be caused on the surface of the toner particles. That is, the toner particles containing the ethylene-unsaturated carboxylic acid copolymer as the binder resin may not be readily charged to have a desired charge amount. However, according to the present embodiment, the toner particles of the toner have a shell layer that contains a nitrogen atom derived from melamine or urea. Consequently, the toner particles according to the present embodiment are positively charged to readily have a desired charge amount. Therefore, when the toner according to the present embodiment is used to form images at a high coverage rate, the toner particles can be promptly charged to have a desired charge amount even though the toner particles stays in the developing unit only for a short period of time. This leads to the reduction of fogging of images to be formed. The content of the nitrogen atom in the shell layers is preferably 10% by mass or more to facilitate the charging of the toner particles to have a desired charge amount.

The resin that forms the shell layers may contain a unit derived from a thermoplastic resin. The thermoplastic resin has a functional group that is reactive with the functional group present in the monomer of the thermosetting resin described above (for example, methylol group or amino group). As described above, the shell layers contain a unit derived from a monomer of a thermosetting resin and a unit derived from a thermoplastic resin. Consequently, the shell layers combine an adequate level of flexibility and an adequate level of mechanical strength, the former resulting from the unit derived from the thermoplastic resin, and the latter resulting from the three-dimensional cross-linking structure of the monomer of the thermosetting resin.

Examples of the functional group reactive with a methylol group or amino group include a functional group containing an active hydrogen atom, such as a hydroxyl group, a carboxyl group, or an amino group. The amino group may be contained in the thermoplastic resin in the form of a carbamoyl group (—CONH₂). To allow easy formation of the shell layers, preferred examples of the thermoplastic resin include a resin containing a unit derived from (meth)acrylamide and a resin containing a unit derived from a monomer having a functional group, such as a carbodiimide group, an oxazoline group, or a glycidyl group.

The content of the unit derived from the monomer of the thermosetting resin is preferably 70% by mass or more with respect to the shell layers, more preferably 80% by mass or more, particularly preferably 90% by mass or more, and most preferably 100% by mass.

The thickness of the shell layers is preferably 1 nm or more and 20 nm or less, and more preferably 1 nm or more and 10 nm or less. When the shell layers of the toner particles are too thick, the following risk is likely to arise when an image is formed with the use of the toner containing such toner particles. That is, the shell layers may not rupture when pressure is applied to the toner particles for fixing the toner to a recording medium. In addition, the softening or melting of the binder resin and the mold releasing agent contained in the toner cores may not smoothly progress, which makes it difficult to fix the toner on a recording medium at low temperatures. On the other hand, the shell layers that are too thin are low in strength. The shell layers of a low strength may accidentally rupture due to an impact given during, for example, transportation. In addition, when the toner is stored at high temperatures, toner particles having a shell layer that is ruptured at least partly may aggregate for the following reason. That is, under high-temperature conditions, a component such as a mold releasing agent may exude to the surface of the toner particles through the ruptured portions of the shell layers.

The shell layer thickness can be measured by analyzing a TEM image of a cross-section of the toner particle with the use of commercially available image-analyzing software. Examples of the commercially available image-analyzing software include WinROOF (manufactured by Mitani Corporation). More specifically, on the cross-section of a toner particle, two straight lines are drawn to intersect at right angles substantially on the center of the cross-section. Then, on the two straight lines, the length of each of four line segments crossing the shell layer is measured. The average of the lengths of the four segments thus measured is determined to be the thickness of the shell layer of the one toner particle subjected to the measurement. In this way, the shell layer thickness is measured on ten or more toner particles to calculate the average thickness of the shell layers of the respective toner particles subjected to the measurement. The average thickness thus calculated is determined to be the thickness of the shell layers of the toner particles.

When a shell layer is too thin, a TEM image may not clearly show the boundary between the shell layer and the toner core, which makes it difficult to measure the thickness of the shell layer. In such a case, the TEM photography may be combined with energy dispersive X-ray spectroscopy (EDX) to clarify on the TEM image the boundary between the shell layer and the toner core through mapping of the element characteristic to the material of the shell layers (nitrogen, for example). Then, the thickness of the shell layer can be appropriately measured.

The thickness of the shell layers can be adjusted by adjusting the amount of the material (the monomer of the thermosetting resin) used to form the shell layers. The shell layer thickness may be estimated by using the following expression based on the specific surface of the toner core and the amount of the monomer of the thermosetting resin and additionally on the amount of thermoplastic resin, if necessary.

Thickness of Shell Layer=(Amount of Monomer of Thermosetting Resin+Amount of Thermoplastic Resin)/Specific Surface of Toner Core

### [External Additive]

The toner according to the present embodiment may include an external additive adhered to the surface of the toner particles, if necessary.

Examples of the external additive include silica and metal oxides (alumina, titanium oxide, magnesium oxide, zinc oxide, strontium titanate, and barium titanate).

The particle size of the external additive is preferably 0.01 μm or more and 1.0 μm or less.

The amount of the external additive to be used is preferably 1 part by mass or more and 10 parts by mass or less with respect to 100 parts by mass of the toner mother particles, and more preferably 2 parts by mass or more and 5 parts by mass or less.

### [Carrier]

The toner may be mixed with a desired carrier to be used as a two-component developer. To prepare a two-component developer, it is preferable to use a magnetic carrier.

Preferred examples of the carrier include a carrier whose particles have resin-coated carrier cores. Specific examples of the carrier core include: particles of iron, oxidized iron, reduced iron, magnetite, copper, silicon steel, ferrite, nickel, or cobalt; particles of alloys of one or more of these materials and a metal, such as manganese, zinc, or aluminum; particles of iron-nickel alloys or iron-cobalt alloys; particles of ceramics, such as titanium oxide, aluminum oxide, copper oxide, magnesium oxide, lead oxide, zirconium oxide, silicon carbide, magnesium titanate, barium titanate, lithium titanate, lead titanate, lead zirconate, or lithium niobate; and particles of high-dielectric substances, such as ammonium dihydrogen phosphate, potassium dihydrogen phosphate, or Rochelle salt. As the carrier, a resin carrier containing any of the above particles (magnetic particles) dispersed in the resin may be used.

Examples of the resin coating the carrier core include (meth)acrylic-based polymers, styrene-based polymers, styrene-(meth)acrylic-based copolymers, olefin-based polymers (polyethylene, chlorinated polyethylene, and polypropylene), polyvinyl chloride, polyvinyl acetate, polycarbonate, cellulose resins, polyester resins, unsaturated polyester resins, polyamide resins, polyurethane resins, epoxy resins, silicone resins, fluorine resins (polytetrafluoroethylene, polychlorotrifluoroethylene, and polyvinylidene fluoride), phenol resins, xylene resins, diallylphthalate resins, polyacetal resins, and amino resins. These resins may be used singly or two or more types may be used in combination.

The particle size of the carrier measured under an electron microscope is preferably 20 μm or more and 120 μm or less, and more preferably 25 μm or more and 80 μm or less.

When the toner is used as a two-component developer, the amount of the toner contained in the two-component developer is preferably 3% by mass or more and 20% by mass or less with respect to the mass of the two-component developer, and more preferably 5% by mass or more and 15% by mass or less.

### [Method for Manufacturing Toner]

A preferred method for manufacturing the toner involves coating the toner cores with a shell layer formed from the predetermined materials described above. In relation to a preferred method for manufacturing the electrostatic latent image developing toner according to the present embodiment, the following sequentially describes a method for manufacturing the toner cores and a method for forming the shell layers.

### [Method for Manufacturing Toner Cores]

Preferably, the method for manufacturing the toner cores can sufficiently disperse components, such as a colorant, a charge control agent, a mold releasing agent, and a magnetic powder in the binder resin. Examples of the method for manufacturing the toner cores include an aggregation method.

Preferably, the zeta-potential of the toner cores measured in an aqueous medium adjusted to pH of 4 is negative (less than 0 mV). More specifically, to form a shell layer on the surface of each toner core, the toner cores need to be sufficiently dispersed in an aqueous medium containing a dispersant. Otherwise, the shell layers formed on the toner cores tend not to be uniform. However, when the zeta-potential of the toner cores is negative, the toner cores that are negatively charged in the aqueous medium and the monomer of the thermosetting resin that is a nitrogen-containing compound, and positively charged in the aqueous medium are assumed to be electrically attracted with each other. Therefore, on the surface of the toner cores, the condensation reaction of the monomer of the thermosetting resin adsorbed to the toner cores tends to progress sufficiently. With the reaction sufficiently progressed on the surface of the toner cores, the shell layers are readily formed uniformly on the surface of the toner cores without the need to highly disperse the toner cores in an aqueous medium by using a dispersant.

As described above, with the use of the toner cores showing a negative zeta-potential, it is assumed to be easier to obtain toner particles having the toner cores that are uniformly coated with a shell layer, without using a dispersant. In addition, when the toner particles are manufactured without using a dispersant, which imposes an extremely high drainage load, the following is expected to be achieved. That is, the total organic carbon concentration in the drainage to be discharged during the manufacturing of the toner can be kept to a low level (for example, 15 mg/L or below) without dilution.

The following describes a method for manufacturing the toner cores by an aggregation method. The toner cores prepared by an aggregation method are likely to be uniform in shape and particle size.

Preferably, the aggregation method involves an aggregation process and a coalescing process as shown below. The aggregation process involves causing the particulates containing the components for forming the toner cores to aggregate in an aqueous medium to form aggregated particles. The coalescing process involves causing the components contained in the aggregated particles to coalesce in the aqueous medium to form toner cores.

### [Aggregation Process]

The aggregation process uses particulates containing the components for forming the toner cores (hereinafter, referred to as core particulates). The core particulates contain the binder resin described above and may also contain components, such as a colorant, a mold releasing agent, and/or a charge control agent.

For example, the binder resin (or the composition containing the binder resin) is micronized in an aqueous medium to a desired size. As a result, an aqueous dispersion liquid containing the core particulates can be prepared. In addition, the aqueous dispersion liquid containing the core particulates may also contain particulates other than the particulates containing the binder resin. Examples of the particulates other than those containing the binder resin include particulates of a colorant, particulates of a mold releasing agent, and particulates of both a colorant and a mold releasing agent. The following sequentially describes a method for preparing the particulates containing the binder resin, a method for preparing the particulates of the mold releasing agent, and a method for preparing the particulates of the colorant.

### (Method for Preparing Particulates Containing Binder Resin)

The following describes a preferred example of a method for preparing particulates containing the binder resin.

A resin composition containing the binder resin and one or more optional components added as needed is coarsely crushed using a crusher, such as a turbo mill Subsequently, the coarsely crushed product is dispersed in an aqueous medium, such as ion exchanged water, and heated at least to a temperature given by (Tmᵣ+10° C.), which is a temperature higher by 10° C. than the softening point (Tmᵣ) of the binder resin measured by a flow tester, and at most to 200° C. Subsequently, a strong shear force is applied to the heated dispersion liquid containing the binder resin using a high-speed shear emulsification device, such as CLEARMIX (manufactured by M TECHNIQUE Co., Ltd.), for example. This yields an aqueous dispersion liquid containing the particulates that contain the binder resin (hereinafter, referred to as “resin dispersion liquid”).

When two or more different ethylene-unsaturated carboxylic acid copolymers are used as the binder resin, the respective ethylene-unsaturated carboxylic acid copolymers may be crushed and mixed or a mixture of the respective ethylene-unsaturated carboxylic acid copolymers may be melted and kneaded, followed by crushing.

The volume average particle size (D₅₀) of the particulates containing the binder resin is preferably 1 μm or less, and more preferably 0.05 μm or more and 0.5 μm or less. When the particle size (D₅₀) of the particulates containing the binder resin is 1 μm or less, the toner cores can be readily prepared to have a sharp particle size distribution and a uniform shape. The volume average particle diameter (D₅₀) of the particulates containing the binder resin can be measured using a device such as a laser diffraction particle size distribution measuring device (for example, SALD-2200 manufactured by Shimadzu Corporation).

The resin dispersion liquid preferably contains a surfactant. The presence of the surfactant in the resin dispersion liquid facilitates the particulates containing the binder resin to be stably dispersed in the aqueous medium.

Examples the surfactant that can be contained in the resin dispersion liquid can be appropriately selected from the group consisting of an anionic surfactant, a cationic surfactant, and a nonionic surfactant. Examples of the anionic surfactant include sulfuric acid ester salt type surfactants, sulfonic acid salt type surfactants, phosphoric acid ester salt type surfactants, and soaps. Examples of the cationic surfactants include amine salt type surfactants and quaternary ammonium salt type surfactants. Examples of the nonionic surfactants include polyethylene glycol type surfactants, alkylphenol ethylene oxide adduct type surfactants, and polyvalent alcohol type surfactants formed from a derivative of a polyvalent alcohol (such as glycerin, sorbitol, or sorbitan). Among these surfactants, anionic surfactants are preferred. These surfactants may be used singly or two or more types may be used in combination.

The amount of the surfactant to be used is preferably 0.01% by mass or more and 10% by mass or less with respect to the mass of the binder resin.

To prepare the toner cores, the ethylene-unsaturated carboxylic acid copolymer (resin) containing carboxyl groups is used as the binder resin. Therefore, when the binder resin is simply micronized in an aqueous medium, the specific surface of the binder resin increases. Due to the influence of the acidic groups exposed on the surface of the particulates containing the binder resin, the pH of the aqueous medium may decrease to the order of 3 to 4. In an aqueous medium having a pH on the order of 3 to 4, the particulates containing the binder resin may not be micronized to a desired particle size.

With the aim of preventing such problems resulting from the acidic groups, a basic substance may be added to the aqueous medium when the particulates containing the binder resin are prepared. Examples of the basic substance include: alkali metal compounds, such as sodium hydroxide, and potassium hydroxide; ammonia; and organic amine compounds, such as dimethylamine, trimethylamine, monoethylamine, diethylamine, triethylamine, N,N-dimethylethanolamine, aminoethanolamine, N-methyl-N,N-diethanolamine, isopropylamine, iminobispropylamine, 3-ethoxypropylamine, 3-diethylaminopropylamine, sec-butylamine, propylamine, methylaminopropylamine, 3-methoxypropylamine, monoethanolamine, morpholine, N-methylmorpholine, and N-ethylmorpholine. Among these basic substances, diethylamine and/or triethylamine are preferably used. In addition, these basic substances may be used singly or two or more types may be used in combination.

Preferably, the boiling point of the basic substance is 0° C. or more and 250° C. or less. When the boiling point is below 0° C., which is too low, the basic substance tends to evaporate from the aqueous medium and thus the particulates of the binder resin containing the ethylene-unsaturated carboxylic acid copolymer may not be dispersed sufficiently in the aqueous medium. On the other hand, when the boiling point of the basic substance is over 250° C., which is too high, the basic substance tends to remain in the toner cores to decrease the heat resistant preservability of the toner.

The amount of the basic substance to be used is preferably 0.5 mole equivalents or more and 15 mole equivalents or less with respect to the number of moles of the carboxyl groups in the ethylene-unsaturated carboxylic acid copolymer, and more preferably 0.8 mole equivalents or more and 3.0 mole equivalents or less, and particularly preferably 1.0 mole equivalents or more and 2.5 mole equivalents or less. In the case where the content of the unit derived from the unsaturated carboxylic acid in the ethylene-unsaturated carboxylic acid copolymer is 5% by mass or less, the amount of the basic substance to be used is preferably 3 mole equivalents or more and 15 mole equivalents or less, and more preferably 4 mole equivalents or more and 12 mole equivalents or less, and particularly preferably 5 mole equivalents or more and 10 mole equivalents or less. With the amount of the basic substance falling within the above range, the particulates of the binder resin containing the ethylene-unsaturated carboxylic acid copolymer is likely to be sufficiently dispersed in the aqueous medium.

In the case where the organic amine compound and/or ammonia is used as the basic substance, a desolventizing agent may be used for a treatment to remove part of the organic amine compound and/or ammonia from the aqueous dispersion liquid containing the particulates of the binder resin containing the ethylene-unsaturated carboxylic acid copolymer. In this case, the amount of the organic amine compound and/or ammonia to be left in the aqueous dispersion liquid is preferably 0.5 mole equivalents or more with respect to the number of moles of the carboxyl groups in the ethylene-unsaturated carboxylic acid copolymer. With this arrangement, the toner having sufficient heat resistant preservability can be obtained. The content of the organic amine compound and/or ammonia in the toner can be determined by gas chromatography.

### (Method for Preparing Particulates of Mold Releasing Agent)

The following now describes a preferred example of the method for preparing particulates of the mold releasing agent.

A mold releasing agent is crushed in advance to 100 μm or less or a similar extent to yield a powder of the mold releasing agent. To prepare particulates of the mold releasing agent, it is preferable to add the powder of the releasing agent to an aqueous medium containing a surfactant to prepare slurry. The amount of the surfactant to be used is preferably 0.01% by mass or more and 10% by mass or less with respect to the mass of the releasing agent.

Next, the resulting slurry is heated at least to the melting point of the releasing agent. Next, by using a homogenizer (ULTRA-TURRAX T50 manufactured by IKA Works) or a pressure-ejecting type disperser, a strong shear force is applied to the heated slurry to prepare an aqueous dispersion liquid containing particulates of the mold releasing agent (hereinafter, referred to as a releasing-agent dispersion liquid). Examples of the device for applying a strong shear force to a dispersion liquid include NANO3000 (manufactured by Beryu Co., Ltd.), Nanomizer (manufactured by YOSHIDA KIKAI CO., LTD.), Microfluidizer (manufactured by MFI), Gaulin Homogenizer (manufactured by Manton Gaulin), and CLEARMIX W-MOTION (manufactured by M TECHNIQUE Co., Ltd.)

The volume average particle diameter (D₅₀) of the particulates of the mold releasing agent contained in the releasing-agent dispersion liquid is preferably 1 μm or less, more preferably 0.1 μm or more and 0.7 μm or less, and particularly preferably 0.28 μm or more and 0.55 μm or less. With the use of particulates of the mold releasing agent having the particle diameter (D₅₀) of 1 μm or less, it is easier to obtain the toner particles with the mold releasing agent uniformly dispersed in the binder resin. The volume average particle size (D₅₀) of the particulates of the mold releasing agent can be measured by using the same method as the measurement of the volume average particle size (D₅₀) of the particulates containing the binder resin.

### (Method for Preparing Particulates of Colorant)

The following now describes a preferred example of the method for preparing particulates of a colorant.

Preferably, a colorant is dispersed in an aqueous medium containing a surfactant by a known disperser, together with a dispersant for colorant (optional component) that is added as needed. This prepares the aqueous dispersion liquid containing particulates of the colorant (hereinafter, referred to as a colorant dispersion liquid). The surfactant to be used may be the same as the surfactant used for preparing the particulates containing the binder resin described above. The amount of the surfactant to be used is preferably 0.01% by mass or more and 10% by mass or less with respect to the mass of the colorant.

Examples of the disperser used for the dispersing include: an ultrasonic disperser; a pressure disperser, such as a mechanical homogenizer, Manton-Gaulin, a pressure homogenizer, or a high-pressure homogenizer (manufactured by YOSHIDA KIKAI CO., LTD.); and a medium disperser, such as a sand grinder, a horizontal or vertical bead mill, Ultra Apex Mill (manufactured by Kotobuki Industrial Co., Ltd.), Dyno Mill (manufactured by WAB AG), or MSC Mill (manufactured by Nippon Coke & Engineering Co., Ltd.)

Preferably, the volume average particle diameter (D₅₀) of the particulates of the colorant is 0.01 μm or more and 0.2 μm or less. The volume average particle size (D₅₀) of the particulates of the colorant can be measured by the same method as the one used for measuring the volume average particle size (D₅₀) of the particulates containing the binder resin.

### (Forming Aggregated Particles)

The resin dispersion liquid prepared by using the above method is mixed with the releasing-agent dispersion liquid and/or the colorant dispersion liquid as needed (such that the toner cores will contain predetermined components, for example) and the particulates contained therein are caused to aggregate. As a result, the aqueous dispersion liquid containing the aggregated particles containing the binder resin (hereinafter, referred to as “aggregated-particle dispersion liquid”) is obtained.

One preferred example of the method for aggregating the particulates involves adjusting the pH of the resin dispersion liquid, adding a coagulant to the resin dispersion liquid, and then adjusting the resin dispersion liquid to a predetermined temperature to cause aggregation of the particulates.

Preferred examples of the coagulant include inorganic metal salts, inorganic ammonium salts, and divalent or higher-valent metal complexes. Examples of the inorganic metal salt include: metal salts, such as sodium sulfate, sodium chloride, calcium chloride, calcium nitrate, barium chloride, magnesium chloride, zinc chloride, aluminum chloride, and aluminum sulfate; and inorganic metal salt polymers, such as polyaluminum chloride and polyaluminum hydroxide. Examples of the inorganic ammonium salt include ammonium sulfate, ammonium chloride, and ammonium nitrate. In addition, nitrogen-containing compounds, such as a quaternary ammonium salt type cationic surfactant and polyethylenimine, may also be used as the coagulant.

As the coagulant, a divalent metal salt and a monovalent metal salt are preferred. The coagulants may be used singly or two or more types may be used in combination. When two or more types of the coagulants are used in combination, a combined use of a divalent metal salt and a monovalent metal salt is preferred. The aggregation rate of particulates caused by a divalent metal salt differs from that by a monovalent metal salt. Therefore, a combined use of a divalent metal salt and a monovalent metal salt is likely to ensure the particles resulting from the aggregation to have a sharp particle size distribution while preventing the particle size of the aggregated particles from being larger.

Preferably, the coagulant is added after the pH adjustment of the dispersion liquid of the particulates. The pH of the aqueous dispersion liquid at the time of adding the coagulant is preferably 8 or higher. The coagulant may be added all at once or in portions.

Preferably, the amount of the coagulant to be added is 1 part by mass or more and 50 parts by mass or less with respect to 100 parts by mass of the solid in the aqueous dispersion liquid. It is preferable to appropriately adjust the amount of the coagulant to be added, depending on the type and amount of the anionic or nonionic dispersant contained in the dispersion liquid of the particulates.

The temperature of the aqueous dispersion liquid at the time of causing the aggregation of particulates is preferably equal to or higher than the glass transition point (Tg) of the binder resin and lower than the temperature given by “the glass transition point (Tg) of the binder resin+10° C.”. By heating the aqueous dispersion liquid containing the particulates of the binder resin to such temperatures, the aggregation of the particulates contained in the aqueous medium dispersion liquid can progress sufficiently.

An aggregation terminating agent may be added after the particulates are aggregated to reach a desired particle size. Examples of the aggregation terminating agent include sodium chloride, potassium chloride, and magnesium chloride.

### [Coalescing Process]

The coalescing process involves heating the aggregate-particle dispersion liquid obtained in the above manner to cause the components contained in the aggregated particles to coalesce. As a result, the aqueous dispersion liquid containing the toner cores having a desired particle size is obtained. Preferably, the aggregate-particle dispersion liquid is heated to be equal to or higher than the temperature given by “the glass transition point (Tg) of the binder resin+10° C.” and equal to or lower than the melting point (Tmᵣ) of the binder resin. Heating the aqueous medium dispersion liquid containing the aggregated particles to such temperatures causes the components contained in the aggregated particles to coalesce sufficiently.

The aqueous dispersion liquid containing the toner cores obtained in the coalescing process is directly usable for forming the shell layers. In addition, the aqueous dispersion liquid containing the toner cores obtained in the coalescing process may be subjected to the washing process and the drying process described below to collect the toner cores.

### [Washing Process]

The washing process involves washing with water the toner cores obtained by the above method. One example of the washing method involves collecting wet cake of toner cores from the aqueous liquid containing the toner cores through solid-liquid separation, followed by washing the thus collected wet cake with water. Another method involves causing the toner cores contained in the aqueous liquid to precipitate, replacing the supernatant with water, and then dispersing the toner cores again in water.

### [Drying Process of Toner Cores]

Preferred examples of the method for drying the toner cores include a method performed by using a dryer, such as a spray dryer, a fluidized bed dryer, a vacuum freeze dryer, and a reduced pressure dryer.

### [Method for Forming Shell Layers]

The shell layers coating the toner cores are formed by using a monomer of a thermosetting resin (melamine, urea, or a reaction product of glyoxal and urea). Instead of the monomer of the thermosetting resin, a precursor yielded through an addition reaction between the monomer of the thermosetting resin and formaldehyde (methylolated product) may be used. Preferably, the shell layer formation is carried out in an aqueous medium, such as water, in order to prevent the binder resin and the mold releasing agent contained in the toner cores respectively from being dissolved or eluted in the solvent used for forming the shell layers.

Preferably, the shell layers are formed by adding the toner cores to an aqueous solution in which the materials for forming the shell layers are dissolved. Preferred examples of the method for adding and sufficiently dispersing the toner cores in an aqueous medium include: a method involving mechanical dispersion of the toner cores in the aqueous medium by using a device capable of vigorously stiffing the dispersion liquid; and a method involving dispersion of the toner cores in an aqueous medium containing a dispersant.

Preferred examples of the device capable of vigorous stirring of the dispersion liquid for mechanically dispersing the toner cores in the aqueous medium include HIVIS MIX (manufactured by PRIMIX Corporation).

Preferred examples of the dispersant used in the method for dispersing the toner cores in an aqueous medium include compounds such as sodium polyacrylate, polyparavinyl phenol, partially saponified polyvinyl acetate, isoprene sulfonic acid, polyether, isobutylene-maleic anhydride copolymer, sodium polyaspartate, starch, gelatin, gum arabic, polyvinylpyrrolidone, and sodium lignosulfonate. These dispersants may be used singly or two or more types may be used in combination.

Preferably, the amount of the dispersant to be used is 75 parts by mass or less with respect to 100 parts by mass of the toner cores.

The method for dispersing the toner cores using a dispersant ensures that the toner cores to be highly dispersed in the solvent used for forming the shell layers. Consequently, the respective toner cores can be readily coated uniformly with the shell layers. On the other hand, since the dispersant is used to disperse the toner cores, the dispersant may adhere to the surface of the toner cores prior to the formation of the shell layers. When the shell layers are formed to have the dispersant at the interface between the toner cores and the shell layers, the bonding strength of the shell layers to the toner cores decreases, which increases the risk of peeling of the shell layers from the toner cores due to the mechanical stress applied to the toner particles. In addition, when the dispersant remains in the toner particles, the dispersant may interfere with the charging of the toner particles.

Preferably, the pH of the aqueous dispersion liquid containing the materials for forming the shell layers is adjusted to the order of 4 by using an acidic substance prior to the addition of the toner cores. By adjusting the pH of the dispersion liquid to be acidic, the polycondensation reaction of the later-described materials used for forming the shell layers is accelerated.

After the pH of the aqueous solution of the materials for forming the shell layers is adjusted as needed, the materials may be mixed with the toner cores in the aqueous medium. Subsequently, the materials for forming the shell layers react with one another on the surface of the toner cores in the aqueous dispersion liquid. As a result, the shell layers coating the surface of the toner cores are formed.

The temperature at which the shell layers are formed form the monomer of the thermosetting resin is preferably 40° C. or higher and 95° C. or less, and more preferably 50° C. or more and 80° C. or less. At the temperatures from 40° C. to less than 95° C., the formation of the shell layers proceed favorably.

After the shell layers are formed in the above manner, the aqueous dispersion liquid containing the toner cores each coated with the shell layer is cooled to room temperature to obtain the dispersion liquid of the toner mother particles. Subsequently, the toner is collected from the dispersion liquid of the toner mother particles sequentially through, for example, the washing process of washing the toner mother particles, the drying process of drying the toner mother particles, and the external addition process of causing an external additive to adhere to the surface of the toner mother particles. The following describes the washing process, the drying process, and the external addition process. Note, however, that the washing process, the drying process, and the external addition process can each be omitted appropriately.

### [Washing Process of Toner Mother Particles]

The toner mother particles are washed with water as needed. A preferred example of the method for washing the toner mother particles involves collecting wet cake of toner mother particles from the aqueous dispersion liquid containing the toner mother particles through solid-liquid separation by using a centrifugal method or a filter press method, following by washing the thus collected wet cake with water. Another preferred example of the method for washing the toner mother particles involves precipitating the toner mother particles contained in the aqueous dispersion liquid, replacing the supernatant with water, and then dispersing the toner mother particles again in water.

### [Drying Process of Toner Mother Particles]

The toner mother particles may be dried as needed. Preferred examples of the method for drying the toner mother particles include a method performed by using a dryer, such as a spray dryer, a fluidized bed dryer, a vacuum freeze dryer, and a reduced pressure dryer. To prevent the toner mother particles from aggregating during the drying, a method using a spray dryer is more preferred. With the use of a spray dryer, a dispersion liquid of an external additive, such as silica, can be sprayed together with the dispersion liquid of the toner mother particles. This can cause the external additive to adhere to the surface of the toner mother particles.

### [External Addition Process]

As needed, an external additive may be caused to adhere to the surface of the toner mother particles obtained by the above method. A preferred example of the method for causing the external additive to adhere to the surface of the toner mother particles involves mixing the toner mother particles with the external additive using a mixer, such FM mixer or Nauta mixer, under the conditions to ensure that the external additive is not embedded in the toner mother particles. By causing the external additive to adhere to the toner mother particles, the toner particles are obtained. In the case where the adhesion of the external additive to the surface of the toner mother particles is not involved (the external addition process is omitted), the toner mother particles are considered to be the toner particles.

The electrostatic latent image developing toners according to the present embodiment described above exhibits excellent heat resistant preservability and low-temperature fixability. In addition, the electrostatic latent image developing toner according to the present embodiment can reduce rupturing of the toner particles under a prolonged stress, and ensure the toner particles to be charged to have a desired charge amount when images are formed at a high coverage rate. This leads to the reduction of fogging in images to be formed. Therefore, the electrostatic latent image developing toner according to the present disclosure can be appropriately applied to various image forming apparatuses.

### EXAMPLES

The following describes examples of the present disclosure. It should be noted, however, that the present disclosure is in no way limited to the scope of the examples.

### Manufacture Example 1

### Preparation of Resin Dispersion Liquids a-g

The resin dispersion liquids a-g were each prepared by using, as the binder resin, one of the resins having the physical properties (softening point and melting point) shown in Table 1. In addition, as for each dispersion liquid containing the ethylene-methacrylic acid copolymer-Table 1 shows the content of the unit derived from methacrylic acid in the copolymer (hereinafter, may also referred to as the unsaturated carboxylic acid unit). As for the ethylene-methacrylic acid copolymer and the ethylene-vinyl acetate copolymer, Table 1 shows their respective melt flow rates (MFRs).

Each softening points shown in Table 1 is a Vicat softening point measured according to JIS K7206:1999. In addition, each melting point shown in Table 1 is a value measured according to JIS K7121:1987. The content of the unsaturated carboxylic acid unit contained in each ethylene-methacrylic acid copolymer shown in Table 1 is a value measured by using an FT-IR method. Each MFR shown in Table 1 is a value measured by using a melt indexer (G-01 manufactured by Toyo Seiki Seisaku-sho, Ltd.) according to JIS K7210:1999 (at 190° C. with weight of 2.16 Kg).

TABLE 1

| | | | | Content of | |
|---|---|---|---|---|---|
| | | Soft- | | Unsaturated | |
| | | ening | Melting | Carboxylic | MFR |
| | | Point | Point | Acid Unit | [g/ |
| | | [° C.] | [° C.] | [% by mass] | 10 min] |
| N1050H | Ethylene- | 62 | 98 | 10 | 500 |
| N1035 | Methacrylic | 71 | 95 | 10 | 35 |
| N1560 | Acid Copolymer | 60 | 90 | 15 | 60 |
| N0200H | (Manufactured by | 52 | 88 | 2 | 130 |
| N1525 | Du Pont-Mitsui | 63 | 93 | 15 | 25 |
| | Polychemicals | | | | |
| | Co., Ltd.) | | | | |
| EVA150 | Ethylene-Vinyl | 32 | 61 | — | 30 |
| | Acetate | | | | |
| | Copolymer | | | | |
| | (Manufactured by | | | | |
| | Du Pont-Mitsui | | | | |
| | Polychemicals | | | | |
| | Co., Ltd.) | | | | |
| ST-95 | Ethylene-Acrylic | 95 | 130 | — | — |
| | Copolymer | | | | |
| | (Manufactured by | | | | |
| | Sanyo Chemical | | | | |
| | Industries, Ltd.) | | | | |

The resin dispersion liquids a-g were each prepared through the following procedure.

A hermetically sealable, pressure-proof glass vessel (1-liter capacity) provided with a stirrer having a stirring blade, a thermometer, and a heater was used. To prepare each resin dispersion liquid, the pressure-proof glass vessel was charged with: 100 g of the resin of the corresponding type shown in Table 2; the ammonia aqueous solution (concentration 25% by mass) in the corresponding amount shown in Table 2; and the distilled water in the corresponding amount shown in Table 2. Note that the resin dispersion liquids f and g were prepared without using the ammonia aqueous solution.

After the pressure-proof glass vessel was hermetically sealed, the contents of the vessel were stirred by using the stirrer at a stirring rate of 400 rpm for 30 minutes at room temperature. Next, the contents of the vessel were heated to 170° C. while being stirred at a stirring rate of 400 rpm. Subsequently, the contents of the vessel were further stirred at 170° C. for 60 minutes. Thereafter, the contents of the vessel were cooled to 80° C. over an hour while being stirred at a stirring rate of 400 rpm. Then, the lower half of the glass vessel was immersed in water to be cooled until the temperature inside the vessel reached 35° C. Then, the stirring was stopped. Subsequently, the contents of the glass vessel were filtered through a stainless filter (460 mesh) to obtain the resin dispersion liquid (solid concentration 10% by mass). The volume average particle diameter (D₅₀) of the particulates contained in the resin dispersion liquid was 150 nm. The volume average particle diameter was measured by using a particle size distribution analyzer (LA-950V2 manufactured by HORIBA, Ltd.).

TABLE 2

| Resin | | | |
|---|---|---|---|
| Dispersion | Types of | Amount of Ammonia | Amount of |
| Liquid | Resin | Aqueous Solution [g] | Distilled Water [g] |
| a | N1050H | 19.7 | 885.2 |
| b | N1035 | 19.7 | 885.2 |
| c | N1560 | 29.6 | 877.8 |
| d | N0200H | 3.9 | 994.3 |
| e | N1525 | 29.6 | 877.8 |
| f | EVA150 | — | 900.0 |
| g | ST-95 | — | 900.0 |

### Manufacture Example 2

### Preparation of Colorant Dispersion Liquid

First, 90 g of a cyan colorant (C.I. pigment blue 15:3, copper phthalocyanine), 10 g of an anionic surfactant (EMAL 0 manufactured by Kao Corporation, sodium laurylsulfate), and 400 g of ion exchanged water were mixed. Then, the mixture liquid was emulsified and dispersed over an hour by using Ultimaizer, a high-pressure impact type dispersing machine (HJP 30006 manufactured by Sugino Machine Limited). This yielded the colorant dispersion liquid having a solid concentration of 18% by mass.

### Manufacture Example 3

### Preparation of Mold Releasing-Agent Dispersion Liquid

First, 200 g of a mold releasing agent (WEP-5 manufactured by NOF Corporation, pentaerythritol behenate wax, melting point 84° C.), 2 g of an anionic surfactant (Emal E-27C manufactured by Kao Corporation), and 800 g of ion exchanged water were mixed. Then, the mixture liquid was heated to 100° C. to melt the mold releasing agent, followed by emulsification for 5 minutes by using a homogenizer (ULTRA-TURRAX T50 manufactured by IKA Works). Subsequently, the emulsified liquid was subjected to further emulsification at 100° C. by using Gaulin homogenizer (manufactured by Manton Gaulin). This yielded the releasing-agent dispersion liquid having the volume average particle diameter of 250 nm, the melting point of 83° C., and the solid concentration of 20% by mass.

### Manufacture Example 4

### Preparation of Silica

First, 100 g of dimethylpolysiloxane (manufactured by Shin-Etsu Chemical Co., Ltd.) and 100 g of 3-aminopropyltrimethoxysilane (manufactured by Shin-Etsu Chemical Co., Ltd.) were dissolved in 200 g of toluene, followed by ten-fold dilution to obtain a diluent. Then, the diluent was gradually dripped into 200 g of fumed silica (Aerosil #90 manufactured by Nippon Aerosil Co., Ltd. and registered in Japan) being stirred, followed by ultrasonic irradiation 30 minutes under stirring. The resulting mixture was heated in a constant temperature bath at 150° C., followed by removal of toluene using a rotary evaporator to obtain a solid body. The resulting solid body was dried at the preset temperature of 50° C. by using a reduced pressure dryer until the weight of the solid body would no longer decrease. Then, the resulting solid was treated in an electric furnace for three hours at 200° C. under a nitrogen gas stream to obtain coarse particles of silica. The coarse particles of silica were then cracked by using a jet mill (IDS type Jet Mill manufactured by Nippon Pneumatic Mfg. Co., Ltd.) and collected by using a bag filter to obtain silica.

### Examples 1-5 and 7 and Comparative Examples 2 and 3

### Manufacture of Toner Cores

With the use of the respective dispersion liquids of particulates below, the dispersion liquids containing the toner cores were prepared.

Resin dispersion liquid of a corresponding type shown in Tables 3-5 (solid concentration of 10% by mass): 850 g

Colorant dispersion liquid (solid concentration of 18% by mass): 27.7 g

Releasing-agent dispersion liquid (solid concentration of 20% by mass): 50.0 g

A temperature sensor, a cooling tube, and a stirrer were set to a 1-liter four-necked flask. The four-necked flask was charged with: 850 g of the resin dispersion liquid of the corresponding type shown in Tables 3-5 (solid concentration of 10% by mass); 20 g of an aqueous solution of anionic surfactant (Emal 0 manufactured by Kao Corporation) having a concentration of 10% by mass; and 64.3 g of ion exchanged water. Next, 56 g of an aqueous solution of magnesium chloride hexahydrate (coagulant) (concentration: 50% by mass) was added to the flask over 5 minutes while the contents of the flask were stirred at a stirring rate of 100 rpm. Next, the temperature inside the flask was raised to 40° C. at 2° C./min, and then the contents of the flask were stirred for 30 minutes at a stirring rate of 100 rpm. Next, the temperature inside the flask was raised to 80° C. at 1° C./min, and then the contents of the flask were stirred for 2 hours at a stirring rate of 100 rpm. As a result, the particulates contained in the dispersion liquid proceeded to aggregate. Then, 370 g of the aqueous solution of sodium chloride (aggregation terminating agent) (concentration: 50% by mass) was added to the flask, and then the dispersion liquid was stirred for ten minutes at a stirring rate of 350 rpm. After the stirring, the dispersion liquid was cooled to 25° C. at a rate of 5° C./min. As a result, the dispersion liquid containing the toner cores was obtained. From each of the thus obtained dispersion liquids of the toner cores, the toner cores were collected according to the following method.

### <Method for Collecting Toner Cores>

The pH of each dispersion liquid of the toner cores was adjusted to 2 with the use of hydrochloric acid, and wet cake of the toner cores was collected by filtering the dispersion liquid of the toner cores through filter cloth having an opening of 1 μm. Thereafter, the wet cake of the toner cores were again dispersed in ion exchanged water to wash the toner cores. The process of filtering and dispersing were repeated five times to wash the toner cores. The wet cake of toner cores thus washed was dried in vacuum at 40° C. Consequently, the dried toner cores were obtained.

### (Process of Forming Shell Layers)

First, a 1-litter, three-necked flask provided with a stirring blade and a thermometer was charged with 300 mL of ion exchanged water. Then, the temperature inside the flask was maintained at 30° C. with the use of a water bath. Then, dilute hydrochloric acid was added to the flask to adjust the pH of the aqueous medium in the flask to 4. After the pH adjustment, an aqueous solution of methylol melamine (mirben resin SM-607 manufactured by Showa Denko K.K., solid concentration 80% by mass) was added to the flask as the raw materials of the shell layers (shell material), in a corresponding amount shown in Tables 3-5. Then, the contents of the flask were stirred to dissolve the raw material of the shell layers into the aqueous medium. As a consequence, the aqueous solution of the material of the shell layers (aqueous solution A) was obtained.

Then, to the aqueous solution (A), 300 g of the toner cores of the corresponding type shown in Tables 3-5 was added, and then the contents of the flask were stirred for one hour at a rate of 200 rpm. Subsequently, 300 mL of ion exchanged water was added to the flask. Thereafter, the temperature inside the flask was raised to 70° C. (shell-layer forming temperature) at a rate of 1° C./min while the contents of the flask were stirred at 100 rpm. The contents of the flask were then continued to be stirred for two hours at 70° C. and 100 rpm. Thereafter, sodium hydroxide was added to the flask to adjust the pH of the contents to 7. Subsequently, the contents of the flask were cooled to room temperature. Consequently, the dispersion liquid containing the toner mother particles was obtained.

### (Washing Process)

With the use of a Büchner funnel, the wet cake of toner mother particles was collected by filtering from the dispersion liquid containing the toner mother particles. Thereafter, the wet cake of the toner particles were again dispersed in ion exchanged water to wash the toner mother particles. The process of filtering and dispersing were repeated five times to wash the toner mother particles.

### (Drying Process)

The wet cake of the toner mother particles were dispersed in an ethanol solution having a concentration of 50% by mass to prepare slurry. The thus obtained slurry was supplied to a continuous type surface modifier (Coatmizer manufactured by Freund Corporation and registered in Japan) to dry the toner mother particles contained in the slurry. Consequently, the dried toner mother particles were obtained. The drying by Coatmizer was carried out under the conditions with the hot-blast temperature of 45° C. and the flow rate of 2 m³/min

### (External Addition Process)

First, 100 parts by mass of the toner mother particles obtained through the drying process were mixed with 0.5 parts by mass of silica (REA90 manufactured by Nippon Aerosil Co., Ltd.) by using 10-litter FM mixer (manufactured by Nippon Coke & Engineering Co., Ltd.) for 5 minutes to cause the external additive to adhere. Thereafter, a 200-mesh sieve (opening: 75 μm) was used to sift the toner.

### Example 6

The toner of Example 6 was obtained in the same manner as Example 1, except that the raw materials of the shell layers used in the process of forming shell layers were altered to 1.2 g of urea and 3.0 g of the formalin.

### Comparative Example 1

The process of forming the shell layers was omitted and the toner cores were used as the toner mother particles. The external addition process was carried out in the same manner as Example 1 but with the use of the toner mother particles. As a result the toner of Comparative Example 1 was obtained.

### <<Shell Layer Thickness>>

For each of Examples 1-7, a TEM image of the cross section of a toner particle contained in the corresponding toner was taken according to the following method. The toner of Comparative Example 1 was prepared without the process of forming the shell layers. Naturally, no measurement of the shell layers was carried out. As will be described later, Comparative Examples 2 and 3 failed yield desired evaluation results. Therefore, no measurement of the shell layers was carried out. From each TEM image of the cross section of a toner particle, the shell layer thickness was measured. Tables 3-5 show the shell layer thickness for each of the toners of Examples 1-7.

### <Method for Taking Cross-Sectional TEM Images of Toner Particles>

First, the toner was dispersed in a cold setting epoxy resin and left to stand for two days in an atmosphere of 40° C. to obtain a hardened material. The hardened material thus obtained was dyed with osmium tetroxide. Then, from each resultant hardened material, a 200 nm thick slice was cut as a thin sample for cross-sectional observation of the toner particle by using a microtome (EM UC6 manufactured by RAICA Co. Ltd.) The thin sample was then observed under a transmission electron microscope (TEM) (JSM-6700F manufactured by JEOL Ltd.) at a magnification of 3000× and 10000× to take cross-sectional TEM images of the toner particles.

### <Method for Measuring Shell Layer Thickness>

The shell layer thickness was measured by analyzing each cross-sectional TEM image of a toner particles with image analyzing software (WinROOF manufactured by MITANI CORPORATION). More specifically, on a section of a toner particle, two straight lines were drawn to intersect at right angles substantially at the center of the cross section. Then, on the two straight lines, the length of each of the four line segments crossing the shell layer was measured. The average of the lengths of the four segments thus measured was determined as the thickness of the shell layer of the one toner particle subjected to the measurement. In this way, the shell layer thickness was measured on ten toner particles to calculate the average thickness of the shell layers of the respective toner particles subjected to the measurement. The average thickness thus calculated was determined as the thickness of the shell layers of the toner particles.

### <<Evaluation 1>>

The toners of Examples 1-7 and Comparative Examples 1-3 were evaluated for the heat resistant preservability according to the following method. Tables 3-5 show the evaluation results on the heat resistant preservability of the respective toners of Examples 1-7 and Comparative Examples 1-3.

### <Evaluation of Heat Resistant Preservability>

First, 3 g of each toner was weighed in a 20 ml plastic vessel and left to stand for three hours in a constant temperature chamber that was maintained at 60° C. and then left to stand for another 30 minutes at 25° C. and 65% RH. As a result, the toner for the evaluation of heat resistant preservability was obtained. Thereafter, sieves having different opening sizes including 105 μm, 63 μm, and 45 μm were stacked on one another in order from smallest to largest with the largest one on the top. Then, the toner for evaluation of the heat resistant preservability was put into the 105 μm opening sieve and sifted for 30 seconds by using Powder Tester (manufactured by Hosokawa Micron Corporation) set to the vibration level 5. After the sifting, the mass of the toner left on the 105 μm opening sieve (T₁ (g)), the mass of the toner left on the 63 μm opening sieve (T₂ (g)), and the mass of the toner left on the 45 μm opening sieve (T₃ (g)) were measured and the aggregation degree (percent by mass) of each toner was given by the following expressions.

(T₁/3)×100=C₁

(T₂/3)×100×⅗=C₂

(T₃/3)×100×⅕=C₃

Toner Aggregation Degree (% by mass)=C₁+C₂+C₃

The heat resistant preservability of each toner was evaluated according to the following criteria.

Good: The aggregation degree of the toner was less than 15%.

Poor: The aggregation degree of the toner was 15% by mass or more.

### <<Evaluation 2>>

The toners of Examples 1-7 and Comparative Examples 1-3 were evaluated for the low-temperature fixability and the stress resistance according to the following method. The low-temperature fixability and the stress resistance of each toner were evaluated by using a color printer altered such that the fixing temperature was adjustable (FS-05400DN manufactured by KYOCERA Document Solutions Inc. altered such that the fixing temperature of the fixing device of the color printer was adjustable) within a temperature range for the fixability test. As the recording medium, regular paper was used. For the evaluation of the low-temperature fixability and the stress resistance, a two-component developer prepared according to the following method was used. Tables 3-5 show the evaluation results of the low-temperature fixability and the stress resistance of the respective toners of Examples 1-7 and Comparative Examples 1-3.

### Manufacture Example 5

### Preparation of Two-Component Developer

First, 30 g of a polyamide-imide resin was diluted with 2 L of water to obtain a diluent. In the obtained diluent, 120 g of fluorinated ethylene-propylene copolymer (FEP) was dispersed, and then 3 g of silicon oxide was additionally dispersed to obtain a coat-layer forming liquid. The coat-layer forming liquid and 10 kg of non-coat ferrite carrier (EF-35B manufactured by Powdertech Co., Ltd., Average particle size of 35 μm) were put into a fluid bed coater to form a coating layer on the surface of carrier particles. Subsequently, the obtained product was burnt at 250° C. for one hour to obtain a carrier.

The thus obtained resin-coated ferrite carrier was mixed with each toner of Examples 1-7 and Comparative Examples 1-3 such that the toner density was 10% by mass. As a result, the respective two-component developers were prepared.

### <Evaluation of Low-Temperature Fixability>

Each two-component developer was loaded into a developing unit of a color printer and the toner was loaded into a toner cartridge. Then, unfixed solid images were formed such that the toner carrying amount on a recording medium was 0.5 mg/cm². Then, the fixing was carried out while the fixing temperature was varied within a range of 80° C. to 180° C. to determine the lowest temperature at which no offset occurred. The low-temperature fixability was evaluated according to the following criteria.

Good: The lowest fixing temperature was less than 120° C.

Poor: The lowest fixing temperature was 120° C. or more.

### <Evaluation of Stress Resistance>

With the use of a color printer, a total of 2,000 prints of a white image were continuously produced at 23° C. and 50% RH. Subsequently, the toner was taken out from the developing unit and observed under a reflection type electron microscope at magnification of ×1,000. More specifically, 500 toner particles were observed under the reflection type electron microscope 5 times from a different field of view to measure the number of ruptured toner particles. The stress resistance of each toner was evaluated according to the following criteria.

Very Good: No ruptured toner particles were observed.

Good: One or two ruptured toner particles were observed.

Fair: Three to nine ruptured toner particles were observed.

Poor: Ten or more ruptured toner particles were observed.

### <<Evaluation 3>>

The respective toners of Examples 1-7 and Comparative Examples 1-3 were evaluated for the charge stability and the image fogging according to the following method. The two-component developer prepared according to Manufacture Example 5 described above was used for evaluating each toner as to the charge stability and the image fogging. Tables 3-5 show the evaluation results of the respective toners of Examples 1-7 and Comparative Examples 1-3.

To evaluate the charge stability and the image fogging, a color multifunction peripheral (TASKalfa5550ci manufactured by KYOCERA Document Solutions Inc.) was used as a fixing tester by attaching an external driver and a fixing temperature controller to its fixing section. As the recording medium, regular paper was used. With the use of each cyan toner thus prepared, the color multifunction peripheral was caused to continuously produce a total of 5,000 prints of a color character pattern at a coverage rate of 2% at 20° C. and 65% RH. After 5,000 prints were produced, the color multifunction peripheral was caused to continuously produce a total of 1,000 prints of a color patch pattern at a coverage rate of 50%.

### <Evaluation of Charge Stability>

With the use of a charge amount measuring device, the amount of the electric charge on the toner after the continuous output of 5,000 prints (Q₁) and the amount of the electric charge on the toner after the continuous output of 1,000 prints (Q₂) were measured. Then, the change between the respective charge amounts on the toner (|Q₂−Q₁|) was calculated to evaluate the charge stability according to the following criteria.

Good: |Q₂−Q₁| was less than 7 μC/g.

Poor: |₂−Q₁| was 7 μC/g or more.

### <Evaluation of Image Fogging>

After a total of 1,000 prints of a color patch pattern were continuously produced, an evaluation patch pattern was formed for the evaluation of image fogging. The value of the fogging density was calculated by subtracting the image density of blank paper before image output from the image density of a blank portion in the evaluation patch pattern thus formed. The image fogging was evaluated according to the following criteria.

Good: The fogging density was less than 0.010.

Poor: The fogging density was 0.010 or more.

### <<Comprehensive Evaluation>>

The comprehensive evaluations of Examples 1-7 and Comparative Examples 1-3 were made based on the results of Evaluations 1-3 in which the respective toners were evaluated for the heat resistant preservability, the low-temperature fixability, the stress resistance, the charge stability, and the image fogging. In the comprehensive evaluation, each toner was evaluated as “Good”, on condition that the toner received no “Poor” evaluation result for the heat resistant preservability, the low-temperature fixability, the stress resistance, the charge stability, and the image fogging. In the comprehensive evaluation, each toner was evaluated as “Poor”, on condition that the toner received a “Poor” evaluation result for any of the heat resistant preservability, the low-temperature fixability, the stress resistance, the charge stability, and the image fogging. Tables 3-5 show the comprehensive evaluation results of Examples 1-7 and Comparative Examples 1-3.

TABLE 3

| | Example | | | |
|---|---|---|---|---|
| | 1 | 2 | 3 | 4 |
| Toner Core | | | | |
| Type of Resin | a | b | c | d |
| Dispersion Liquid | | | | |
| Type of | Ethylene-Methacrylic | Ethylene-Methacrylic | Ethylene-Methacrylic | Ethylene-Methacrylic |
| Binder Resin | Acid Copolymer | Acid Copolymer | Acid Copolymer | Acid Copolymer |
| Content of Unit Derived | 10 | 10 | 15 | 2 |
| from Unsaturated | | | | |
| Carboxylic Acid | | | | |
| [% by mass] | | | | |
| Shell Layer | | | | |
| Type of | Methylol Melamine/ | Methylol Melamine/ | Methylol Melamine/ | Methylol Melamine/ |
| Raw Material/ | 2.0 mL | 2.0 mL | 2.0 mL | 2.0 mL |
| Addition Amount | | | | |
| Shell Layer | 6.0 | 6.0 | 6.0 | 6.0 |
| Thickness [nm] | | | | |
| Evaluation 1 | | | | |
| Heat Resistant | | | | |
| Preservability | | | | |
| Aggregation Degree | 2 | 4 | 3 | 7 |
| [% by mass] | | | | |
| Evaluation Result | Good | Good | Good | Good |
| Evaluation 2 | | | | |
| Low-Temperature | | | | |
| Fixability | | | | |
| Lowest Fixing | 112 | 118 | 115 | 112 |
| Temperature [° C.] | | | | |
| Evaluation Result | Good | Good | Good | Good |
| Stress Resistance | | | | |
| Evaluation Result | Very Good | Very Good | Very Good | Good |
| Evaluation 3 | | | | |
| Charge Stability | | | | |
| \|Q₂ − Q₁\| [μC/g] | 2.8 | 3.2 | 2.1 | 5.4 |
| Evaluation Result | Good | Good | Good | Good |
| Image Fogging | | | | |
| Fogging Density | 0.005 | 0.004 | 0.002 | 0.007 |
| Evaluation Result | Good | Good | Good | Good |
| Comprehensive Evaluation Result | Good | Good | Good | Good |

TABLE 4

| | Example | | |
|---|---|---|---|
| | 5 | 6 | 7 |
| Toner Core | | | |
| Type of Resin | e | a | a |
| Dispersion Liquid | | | |
| Type of | Ethylene- | Ethylene- | Ethylene- |
| Binder Resin | Methacrylic | Methacrylic | Methacrylic |
| | Acid | Acid | Acid |
| | Copolymer | Copolymer | Copolymer |
| Content of Unit | 15 | 10 | 10 |
| Derived from | | | |
| Unsaturated | | | |
| Carboxylic Acid | | | |
| [% by mass] | | | |
| Shell Layer | | | |
| Type of Raw | Methylol | Urea/ | Methylol |
| Material/ | Melamine/ | 1.2 g | Melamine/ |
| Addition Amount | 2.0 mL | Formalin/ | 4.0 mL |
| | | 3.0 g | |
| Shell Layer | 6.0 | 6.0 | 12.0 |
| Thickness [nm] | | | |
| Evaluation 1 | | | |
| Heat Resistant | | | |
| Preservability | | | |
| Aggregation Degree | 5 | 10 | 1 |
| [% by mass] | | | |
| Evaluation Result | Good | Good | Good |
| Evaluation 2 | | | |
| Low-Temperature | | | |
| Fixability | | | |
| Lowest Fixing | 114 | 112 | 120 |
| Temperature [° C.] | | | |
| Evaluation Result | Good | Good | Good |
| Stress Resistance | | | |
| Evaluation Result | Very | Very | Very |
| | Good | Good | Good |
| Evaluation 3 | | | |
| Charge Stability | | | |
| \|Q₂ − Q₁\|[μC/g] | 1.9 | 6.0 | 1.8 |
| Evaluation Result | Good | Good | Good |
| Image Fogging | | | |
| Fogging Density | 0.002 | 0.009 | 0.003 |
| Evaluation Result | Good | Good | Good |
| Comprehensive | Good | Good | Good |
| Evaluation Result | | | |

TABLE 5

| | Comparative Example | | |
|---|---|---|---|
| | 1 | 2 | 3 |
| Toner Core | | | |
| Type of Resin | a | f | g |
| Dispersion Liquid | | | |
| Type of Binder Resin | Ethylene- | Ethylene- | Styrene- |
| | Methacrylic | Vinyl Acetate | Acrylic |
| | Acid Copolymer | Copolymer | Copolymer |
| Content of Unit | 10 | — | — |
| Derived from | | | |
| Unsaturated | | | |
| Carboxylic Acid | | | |
| [% by mass] | | | |
| Shell Layer | | | |
| Type of Raw Material/ | — | Methylol | Methylol |
| Addition Amount | | Melamine/ | Melamine/ |
| | | 2.0 mL | 2.0 mL |
| Shell Layer Thickness | — | — | — |
| [nm] | | | |
| Evaluation 1 | | | |
| Heat Resistant | | | |
| Preservability | | | |
| Aggregation Degree | 41 | 14 | 10 |
| [% by mass] | | | |
| Evaluation Result | Poor | Good | Good |
| Evaluation 2 | | | |
| Low-Temperature | | | |
| Fixability | | | |
| Lowest Fixing | 110 | 118 | 135 |
| Temperature[° C.] | | | |
| Evaluation Result | Good | Good | Poor |
| Stress Resistance | | | |
| Evaluation Result | Very Good | Poor | Good |
| Evaluation 3 | | | |
| Charge Stability | | | |
| \|Q₂ − Q₁\| [μC/g] | 8.6 | 2.9 | 1.9 |
| Evaluation Result | Poor | Good | Good |
| Image Fogging | | | |
| Fogging Density | 0.015 | 0.005 | 0.006 |
| Evaluation Result | Poor | Good | Good |
| Comprehensive | Poor | Poor | Poor |
| Evaluation | | | |
| Result | | | |

In Examples 1-7, the toner particles of the respective toners were each formed from a toner core containing the binder resin and a shell layer coating the surface of the toner core. In addition, the binder resin contained an ethylene-unsaturated carboxylic acid copolymer, and the shell layers contained a unit derived from a monomer of a thermosetting resin. The thermosetting resin was at least one selected from the group of amino resins consisting of a melamine resin, a urea resin, and a glyoxal resin. As shown in Tables 3-5, the respective toners of Examples 1-7 exhibited excellent heat resistant preservability and low-temperature fixability, and rupturing of the toner particles under a prolonged stress was shown to be suppressed. As a consequence, the toner particles were ensured to be charged to have a desired charge amount for forming images at a high coverage rate while occurrence of fogging in the images formed was duly reduced.

Comparison of Example 6 with Examples 1-5 as well as with Example 7 revealed that the heat resistant preservability was more favorable for the toner containing the toner particles having a shell layer containing a melamine resin. In addition, with these toners, images were formed at a high coverage rate while occurrence of fogging in the images formed was readily suppressed, and the toner particles were readily charged to have a desired charge amount.

Comparison of Example 4 with Examples 1-3 as well as with Examples 5-7 revealed the following. That is, when the content of the unit derived from unsaturated carboxylic acid in the ethylene-unsaturated carboxylic acid copolymer was 5% by mass or more and 15% by mass or less, rupturing of the toner particles under a prolonged stress was suppressed.

In Comparative Example 1, the toner particles of the toner was without a shell layer. Such a toner was inferior in the heat resistant preservability. Thus, forming images at a high coverage rate with the toner resulted in failure to charge the toner particles to have a desired charge amount, leading to occurrence of fogging in images formed. In Comparative Example 1, the following was assumed. That is, the toner particles of the toner were prone to exudation of the components, such as a mold releasing agent contained in the toner cores, to the surface of the toner particles. This resulted in decrease in the heat resistant preservability.

In Comparative Example 2, the toner particles of the toner each included a toner core containing an ethylene-vinyl acetate copolymer as the binder resin. Such a toner was shown to be incapable of suppressing rupturing of the toner particles under a prolonged stress. It was because the toner particles of the toner of Comparative Example 2 would deform when stirred in a developing unit, which would easily lead to rupturing of the shell layers. This is presumed to be the cause for the toner not being unable to suppress rupturing of the toner particles under a prolonged stress.

In Comparative Example 3, the toner particles of the toner each include a toner core containing a styrene-acrylic copolymer as the binder resin. Such a toner was shown to be inferior in the low-temperature fixability. It is presumably because the toner particles of the toner of Comparative Example 3 were less prone to deformation and thus inferior in the low-temperature fixability.

What is claimed is:

1. An electrostatic latent image developing toner comprising:
toner particles each include
a toner core containing a binder resin, and
a shell layer coating a surface of the toner core, wherein
the binder resin contains an ethylene-unsaturated carboxylic acid copolymer,
the shell layers contain a unit derived from a monomer of a thermosetting resin, and
the thermosetting resin is at least one resin selected from the group of amino resins consisting of a melamine resin, a urea resin, and a glyoxal resin.

2. An electrostatic latent image developing toner according to claim 1, wherein
the shell layers contain a melamine resin.

3. An electrostatic latent image developing toner according to claim 1, wherein
a content of the ethylene-unsaturated carboxylic acid copolymer in the binder resin is 70% by mass or more.

4. An electrostatic latent image developing toner according to claim 1, wherein
a content of a unit derived from an unsaturated carboxylic acid present in the ethylene-unsaturated carboxylic acid copolymer is 1% by mass or more and 15% by mass or less.
